(19) United States
(12) Patent Application Publication
(10) Pub. No.: US 2006/0288087 A1
(43) Pub. Date: Dec. 21, 2006

(54) WEB-BASED METHOD AND SYSTEM FOR PROVIDING CONTENT-DRIVEN SERVICE TO INTERNET USERS

(75) Inventor: Jiehyeong Sun, Sunnyvale, CA (US)

Correspondence Address: JIEHYEONG SUN, 151 SOUTH BERNARDO AVE., APT. 19, SUNNYVALE, CA, 94086, US

(73) Assignee: Jiehyeong Sun, Sunnyvale, CA (US)

(21) Appl. No.: 11/160,290

(22) Filed: Jun. 17, 2005

(51) Int. Cl. G06F 15/16

(52) U.S. Cl. 709/218

(57) ABSTRACT

A web-based method and system provides Internet users with expert services driven by the content that users browse. Wherein users browse the web with the said web-based client tool downloaded from the expert service system, the list of experts is consistently retrieved and displayed beside the content from the expert service system depending on the URL or the content. Experts use the same web-based client tool to attach to the content by means of domain, sponsored ads, search key words and URLs of the content. The user may select any rated expert to offer an assortment of content-driven expert services including chat, advice, demo, advertisement and product information, or even make a purchase. The content expert service system as well conducts periodical tasks to crawl Internet, cluster content by category, rank chat sessions and normalize URLs hereafter for the expert to browse and attach.

### BACKGROUND OF THE INVENTION

Subject matter experts and professionals are all over the world but when the Internet users browse the web, it is still challenging to find experts on line to answer their question. Basically, there are two barriers for prior arts or related implementation. First, most contemporary online chat room applications are not sophisticated enough for experts to get to the right audience because most of them concentrate on the experts' expertise. Most implementations either link the content to the experts or merely allow the user to search for the experts. Some implementations create a market place to allow users to post questions and enable experts to bid on the service. But, the turn-around time is inevitably longer than users expect. All these approaches will only start to be effective when the user knows what the problem is or is ready to phrase the problem to find the experts. It is either too late or just plain cumbersome for the user to go the extra mile to phase the question and wait for experts to bid on them. The invention approaches the problem in a new aspect that the expert can choose to attach or listen to a certain set of contents that is closely related to their expertise. When the user browses these content, he will see a list of the subject matter online experts correlative to the content. The online expert list will be constantly updated in accordance with the content. Hence the user can ask the right expert any question related to the content. In this perspective, experts will connect their expertise to the content and users will connect to the expert through the content they are browsing. In another word, this approach is based on a new content driven perspective where content is implicitly pointing to what the user is looking for as well as expert's expertise at any given instance of time.

The second real world barrier is that spending time to wait on line is very expensive for the experts. The Internet web pages have grown exponentially year over year to more than 4 billion pages. In order to have a critical mass of experts willing to spend their time to serve the Internet users, the present invention provides a web-based client tool for numerous novel features to attract the experts. First of all, the experts can attach or listen to any content any time they want. The experts can conveniently attach to a set of clustered content all at once. Secondly, the experts may show the advertisement or product information to the users during a chat session. Thirdly, the experts may even give a user a demo upon the user's consent. Fourthly, the user can also purchase product or service from the expert with the web-based client tool. At last, the experts can also form a group to serve the users so the individual expert can be on and off but the user may always be served by one of the member expert in the group. All these incentive features aim to underpin the experts to provide their services to benefit the users.

With the web-based client tool, the online expert services can be easily implemented and provided. The expert will have all the features they need to serve the user. They don't need to have their own web page or web site. All they need for the service is completely provided in the web-based client tool and system. This empowers the expert to use only the web-based client tool and the expert service system to provide their expert service to any user who has download the web-based client tool as well. Any corporate expert can just download the tool and start to serve the user without any request to change or alter their current IT or web server infrastructure.

### BRIEF SUMMARY OF THE INVENTION

The present invention provides an expert service server system and a web-based client tool to enable any expert to listen on any web page in Internet related to the expert's expertise. When the Internet users browse the content from Internet with the web-based client tool, the expert list will be shown to them with relevant ratings in different categories. In one embodiment, there are categories of domain experts, key word experts, sponsored ad experts and content experts representing versatile ways the expert may attach or listen to the content. When a user starts to chat with an expert, the expert will have the chance to show their advertisement and even product to the Internet users. In one preferred embodiment, the expert can even demo and sell the product directly to user. During the demo, the expert can virtually control the user's built-in browser to show them the answer to their question, a better product or a discount depending on the content and conversation. The web-based client tool also allows experts to record and replay the demo so the expert can serve the users better with less effort.

The expert service server system includes a number of server clusters and a batch server in conjunction with databases to store user, chat, service and content related data. In one embodiment, there are an accounting server cluster, a chat server cluster, an expert service server cluster and a content clustering server. All user, chat, service and content data are stored in different instances of databases to enhance performance and scalability. The web-based client tool can be downloaded from the expert service server cluster and installed in client side. User registration and accounting information are managed by the accounting server cluster and stored in user/chat database. The chat server cluster establishes and manages the persistent connection between the user and the expert. In one preferred embodiment, the chat server cluster implements http tunneling to bypass the firewall when the client can't connect to the server directly. The chat server as well uses Java Message Service (JMS) to subscribe and broadcast message among the cluster. The expert service cluster handles all requests from web-based client tool related to expert services such as showing expert list, advertisement, product and demo, etc.

In addition, the content clustering server periodically starts to crawl Internet, cluster the content by category, normalize and rank the content for experts to browse and select afterward. The content clustering server first crawls Internet by domain and stores the resulting URLs by a set of preset categories. After that, the normalization process eliminates non-discriminative URL parameters to get the minimum-length, normalized URLs pointing to the same content. The resulting URLs are written back to the content clustering database. The content clustering server then reads from the user/chat database to retrieve user chat frequency and length to rank the content accordingly. The results are written back again to the content clustering database. Eventually, the expert may browse and attach to the content URLs by category and rank from the content clustering database with elevated the possibility that users may chat with them.

### BRIEF DESCRIPTION OF THE DRAWINGS

FIG. 1 is a block diagram illustrating the concept of content driven expert service

FIG. 2 is an exemplary diagram for the web-based client tool with lists of experts after a user logs in

FIG. 3 is an exemplary diagram for the web-based client tool after a user initiates a chat session with an expert.

FIG. 4 is a block diagram for the architecture of the expert service system

FIG. 5 is a flowchart diagram describing the process for the expert to attach to the content

FIG. 6 is a flowchart diagram describing the process for the user to chat with the expert

FIG. 7 is a flowchart diagram describing the content clustering and normalization process

### DETAILED DESCRIPTION OF THE INVENTION

Throughout this description, the preferred embodiments and examples should be considered as exemplars, rather than limitations on the system and methods of the present invention.

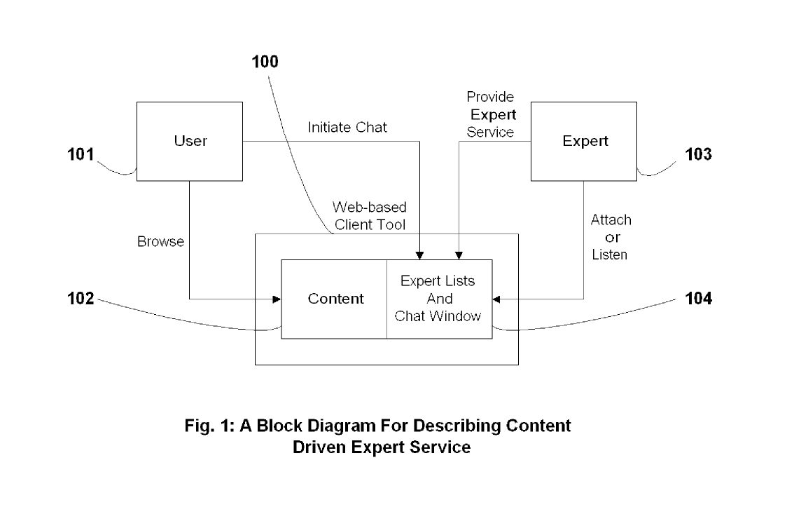

FIG. 1 is a block diagram illustrating the overall concept for the said content driven expert service of the present invention. The said web-base client tool 100 associates the said content 102 with the said expert lists and chat window 104 at any given time therefore the user can select the expert to chat for any content. A said Internet user 101 browses the content from Internet with the web-base client tool in the present invention. The said expert 103 uses the web-based client tool to attach to the content and add themselves to the expert lists. The web-based client tool enables a list of experts to liberally associate their expertise with the corresponding content. The expert only shows up in the expert lists when they are on-line and attach to the content at the moment. When user initiates a chat to a desired expert from the expert lists, the expert can start to chat and provide expert service to the user in the chat window. This approach is different from the other approaches wherein the author of the content determines a set of experts to links to the content. With the web-based client tool, experts can attach themselves to any content in Internet even they are not the owner and do not publish the content by any means.

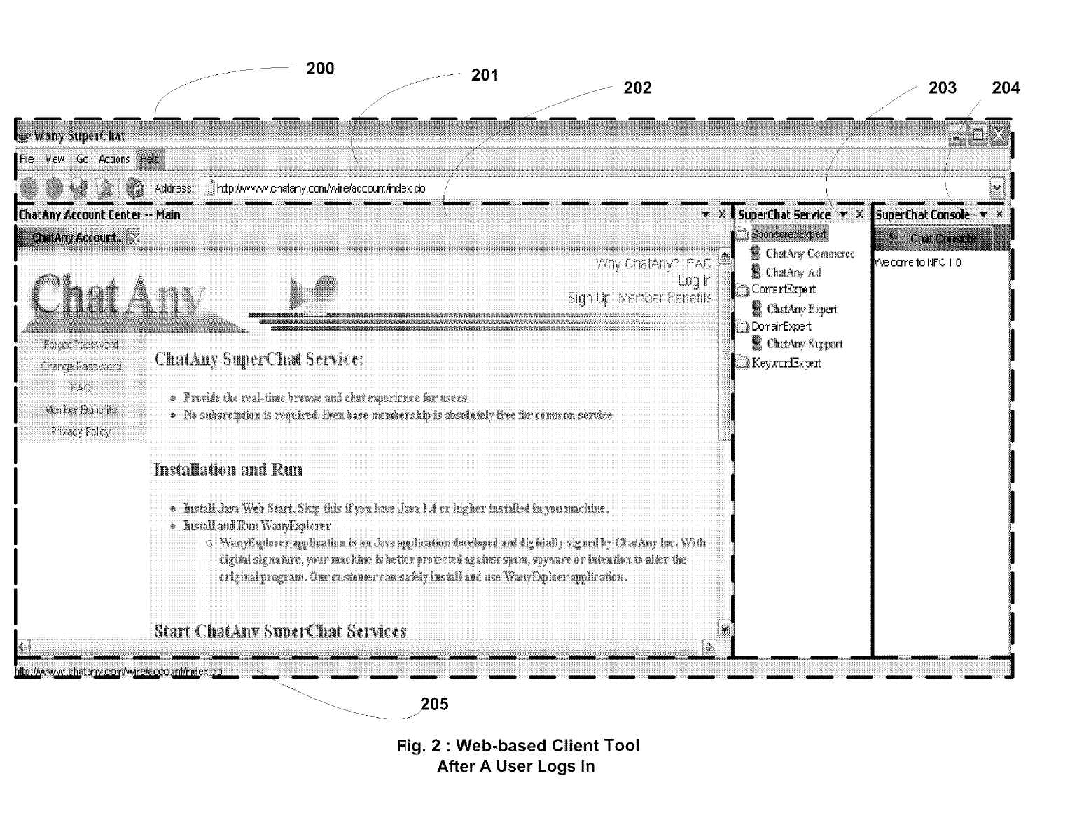

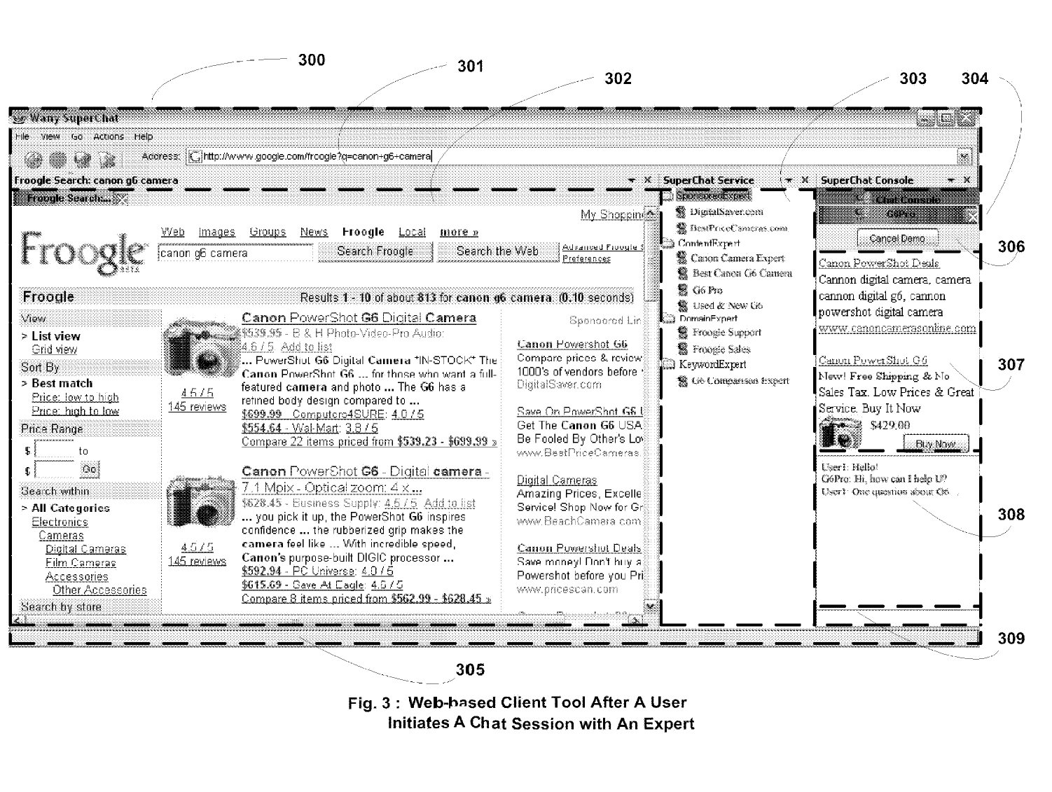

FIG. 2 is an exemplary diagram of a web-based client tool 100 as of FIG. 1 after user has logged in and an expert list has been retrieved from server. A web-based client tool 200 is a downloadable program that can be installed in users' computer. The web-based client tool consists of a said internal browser toolbar 201 and a said built-in browser window 202. The browser toolbar consists of a set of menu and buttons for the fundamental browser functions such as forward, backward, stop, home and address bar but not limited to these functions. The built-in browser window is the main window for showing the web page content retrieved from Internet. In one preferred embodiment of this invention, the built-in browser window is an embeddable Internet Explorer DCOM object. The web-based client tool may query this embedded Internet Explorer object for the current URL and web page content. The said expert list window 203 shows the current on-line experts who have attached themselves to this URL in a variety of ways. In one embodiment of the present invention, there are four different lists of experts such as SponsoredExpert list, ContentExpert list, DomainExpert list and KeywordExpert list that attach to the content shown in the built-in browser window. The lists of experts update automatically when the user browses the content and the URL in toolbar window changes. The SponsoredExpert list shows the expert who inputs and listens on the sponsored ads in a search result page from search engines such as Google, Yahoo, MSN or A9 but not limited to these engines only. The ContentExpert list shows all experts attach or listen to the URL in the browser toolbar. The KeywordExpert list shows all experts attach to a set of particular keywords that are input and searched in the built-in browser window by the user. DomainExpert list shows all experts attach to a particular domain in the browser toolbar. When the user browses to the next page, the expert lists update accordingly following the user's browsing path. A said multi-tab super chat panel 204 shows only the console tab for the output from the expert service clusters after the user or expert has logged in. The multi-tab super chat panel may show more tabs for a chat session such as advertisement, product information and chat window that are explained in detailed later in FIG. 3. A said status window 205 shows either the current URL or any parsing errors of the browser window.

FIG. 3 is an exemplary diagram for the web-based client tool 100 as in FIG. 1 with expert chat, expert advice, expert advertisement and expert product after a user initiates a chat session with an expert. 300, 301, 302, 303, 305 are the same as their counterparts 200, 201, 202, 203, 205 in FIG. 2. The multi-tab chat window 304 is the same as its counterpart 204 except it has one or more chat tabs if the user initiates a chat. Every chat tab consists of a said demo control window 306, a said advertisement and product information window 307, a said message window 308 and a said send message window 309. A said expert advertisement and product information window shows up that contains advertisement and production retrieved from the said expert service database 410 whenever a user initiates a chat session. A message window and a send message window show up as well for the user to type in message and send to expert with a simple carriage return. The experts can request a demo mode from their demo control window and the users can cancel the demo whenever they want in the demo control window. When the user accepts the demo request, the expert and the user will see the same content in their built-in browser window until a demo is cancelled by clicking on the “Cancel Demo” button on the demo control window or a chat is ended. Both users and experts may record the demo and replay the demo later.

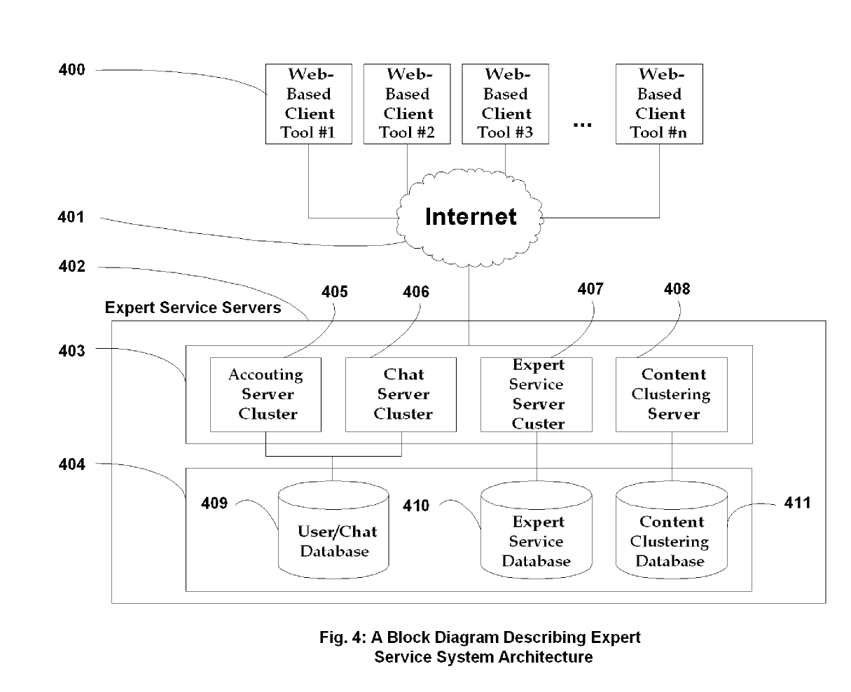

FIG. 4 is a block diagram of the architecture for the expert service system consists of a plurality of said web-based client tool 400 (the same as in 100, 200 and 300) and said expert service servers 402 in accordance with one embodiment of the present invention. The web-based client tool and expert service servers are interconnected with Internet 401. Internet can be in any form of dial up, broadband, wireless PDA or even corporate Intranet as long as they are connected by Internet protocol. The web-based client tool is a binary executable file downloaded from a said expert service cluster 407. One embodiment of the web-based client tool is a Java program downloaded and installed by Java Web Start. The advantage of Java Web Start is that the new version of program updates will be downloaded each time the web-based client tool is started. Expert service servers comprise a variety of server clusters and one content clustering server to provide key system functionalities such as chat, advice, expert service, expert rating, accounting, ranking, advertisement, shopping, etc. In one embodiment, a said accounting server cluster 405, consisting of a plurality of accounting servers, stores user accounting information including user registration, user types, product and ad impressions, and expert rating, etc. A said chat server cluster 406 comprises a plurality of chat servers to handling chat session connection between users and experts. In one embodiment, the servers in the cluster subscribe and broadcast messages among the cluster using Java Messaging Service (JMS). A said expert service server cluster 407 handles all expert related service such as URL listening, chat, advice, expert advertisement and product input and display, expert demonstration, etc. A said content clustering server 408 is executed periodically to cluster, normalize and rank the content in the said content clustering database 411. The content clustering database stores all categorized and normalized content URL with corresponding ranking information in a clustered fashion. User/chat database 409 stores data of user profile and chat session information for accounting purpose. For one embodiment of the present invention, the chat session information contains chat session starting URL, start time, end time, participants, advertisement and product information impressions served and whether there is a demo or not. A said expert service database 410 stores expert specific service information such as expert advertisement, product and demo requests. In one preferred embodiment, all servers 403 are Java web applications or Java program run as a LINUX cron job. All databases 404 are Open Source Relational MySQL Database with JDBC connection Pool between servers and databases. All server clusters are JBoss J2EE Clusters. Struts and Hibernate are used for MVC modeling and OR Mapping, respectively. The chat database and clustered content database tend to accumulate a gigantic amount of data therefore they are running in a separate instance.

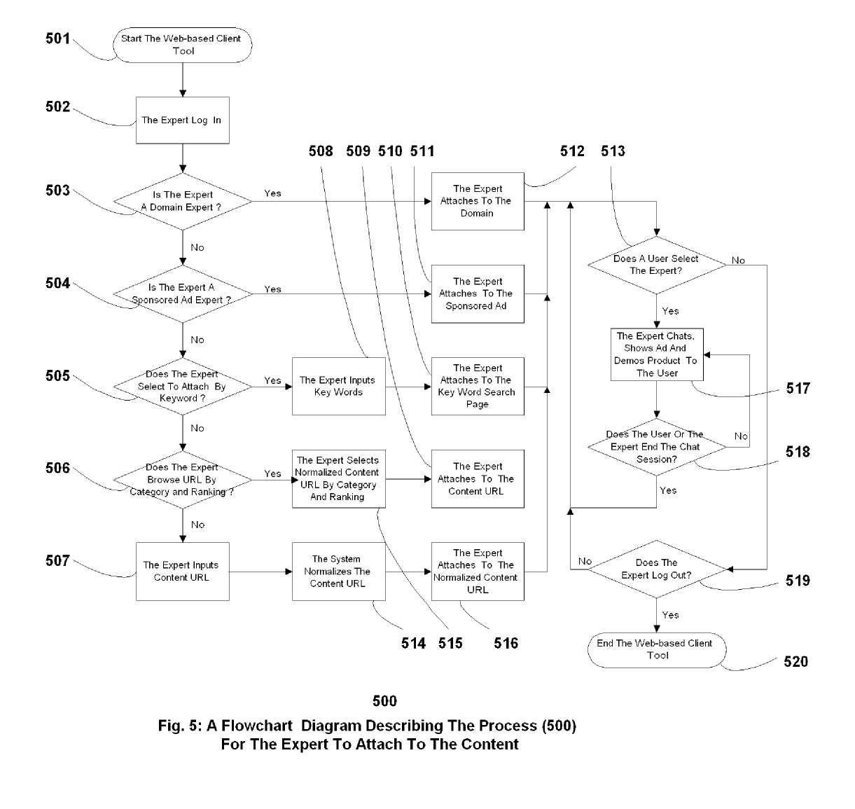

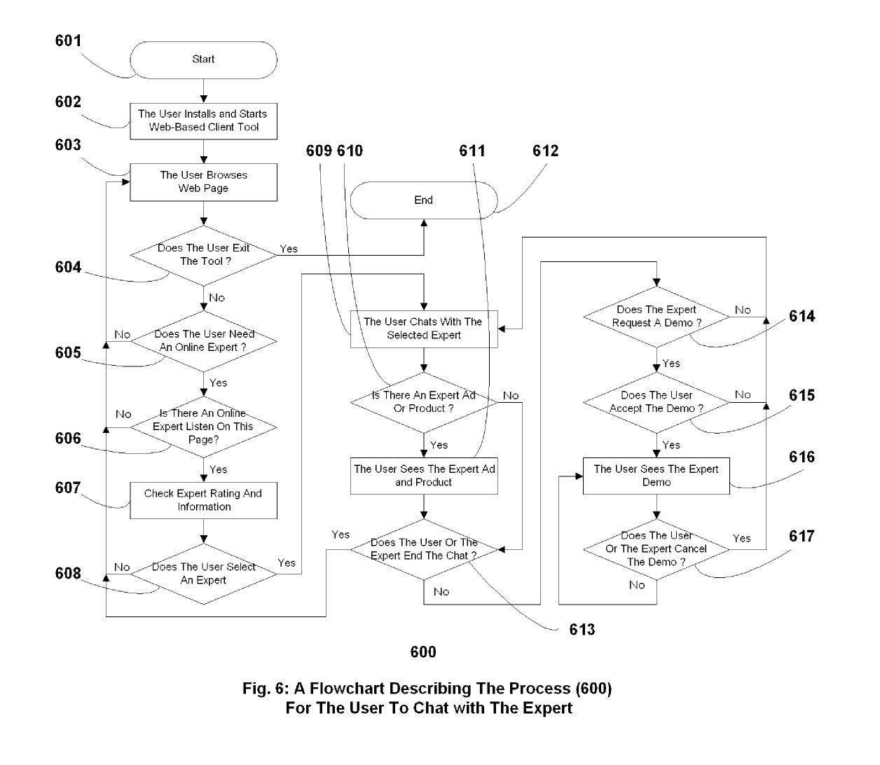

FIG. 5 is a flowchart diagram describing the overall process 500 for the expert to attach to the content. The expert starts the web-base client tool 400 as illustrated in step 501. In one preferred embodiment, the expert has to log in first as in step 502 to ensure the system can rate the expert later on and protect the user by revoking the expert's right in some extreme cases. After the expert logs in, the system will check the user/chat database 409 to see if the expert has registered as a domain expert as in step 503. If the database record shows yes, the expert may attach to all pages under a domain in step 512. If the answer is no in step 503, the system will check if the expert is a sponsored ad expert in step 504. If the database shows the expert is a sponsored ad expert, the expert may attach to the sponsored ad as in step 511. The expert will show up in the expert list window only when the corresponding sponsored ad is shown in the built-in browser window 302. The web-based client tool parses the web page content in real-time to get all sponsored ads and then query the Expert Service Server Cluster 407 to retrieve the expert information. If the expert is not a sponsored ad expert, then the expert may elect to attach by a set key words in step 505. In this case, the expert has to input key words (step 508) and then attaches to the key word search page as in step 510. In one embodiment, the expert may also limit the domain for the key word search to the certain search engine domains only to avoid listen to too many undesired pages. If an expert doesn't want to attach by key words (step 505 No), the expert can browse URL by categories and ranking as in step 506. The system will display a list of normalized content URLs from content clustering database 411 for the expert to browse and select (step 515). The expert then can attach to those selected URLs as in step 509. It the expert does not want to browse URL by categories and ranking (step 506 No). The expert can just input the content URL manually as in step 507. The system will normalize the content URL (step 514) if necessary. The expert then can attach to the normalized content URL as in step 516. After the expert attaches to the content, the user can see the expert and select the expert as in step 513. The expert may listen to multiple pages at the same time that increases the possibility for the user to find a most suitable expert online. On the other hand, the expert is enabled to listen to virtually all web pages that are accessible with the built-in browser. If there is no user selecting the expert, the expert can log out as in step 519. After that, the expert can exit the web-based client tool in step 520. If a user selects the expert as in step 513, then the expert can chat, show advertisement or show product information to the user as in step 517. More detailed about how the expert chats, shows and demos product to the user is in FIG. 6. Either the user or the expert can end a chat session any time they want as illustrated in step 518. After that, the expert can wait for a user to select the expert again as in step 513.

FIG. 6 is a flowchart diagram describing the overall process 600 for a user to chat with an expert. After it starts in 601, the user has to install the web-based client tool 400 the first time and runs it hereinafter in step 602. The user may browse the web page the same way as the regular browser with built in browser window 202 inside the web-based client tool as indicated in step 603. The user may exit the web-based client tool as indicated in step 604 and end in step 612 any time. If a user needs an experts' advice for any content, product or process in the web page as in step 605, he can check if there is any online expert listening on this page in expert list window 203 as in step 606. The user can check the expert lists and expert ratings to select the most relevant expert to their questions as illustrated in step 607. One embodiment of this invention is to allow a user to rate the experts' performance by collecting the feedback from emails sent to users after each chat session. Once a user selects an expert 608 and start a chat session to chat with the selected expert 609, the user will see the expert's advertisement and product information in the advertisement and product information window 307 as in step 611 provided the expert has uploaded them into expert service database 410. The web-based client tool 400 will check with expert service cluster 407 to decide if the expert advertisement and product information has been uploaded and can be shown to the user in step 610. Either the user or the expert may cancel a chat any time as indicated in step 613. During the chat session, an expert can request a demo to a user as in step 614. The user has the option to accept or decline the request as in step 615. The user may see the expert's demo in the browser toolbar 301 and built-in browser window 302 and as illustrated in step 616. Both the browser window for the expert and the user will display the same content during the demo. Either the user or the expert may cancel a demo any time in the demo control window 306 as indicated in step 617 wherein the user will go back to continue chatting with selected experts step 609.

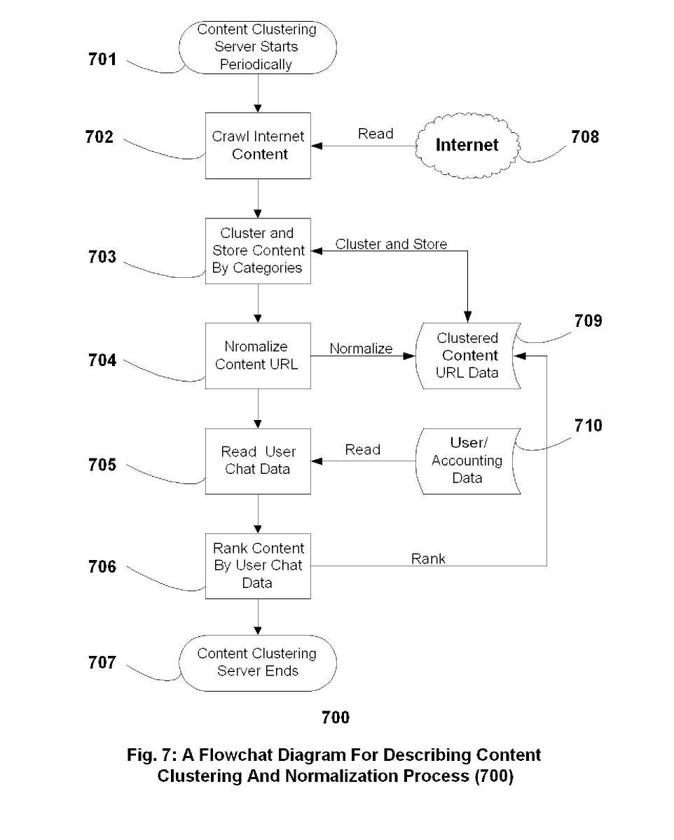

FIG. 7 is a flowchart diagram describing the content clustering and normalization process 700. The content clustering process starts periodically as illustrated in step 701 and in one embodiment, it is a cron job in Linux executed every midnight to start a content clustering server 408. The content clustering server then crawls Internet in step 708 and grabs content domain by domain in step 702. It categorizes and stores the clustered content as in step 703 to clustered content URL data 709 that resides in content clustering database 411. The content URL usually has non-discriminative parameters with different values. Some of these parameters store session id and reference URL that will change depending on the user and referring domain. These differences of the URL can be normalized and stored in the content URL clustered data again as in step 704. Hereafter the content clustering server reads user chat data in step 705 and ranks them based on the user chat frequency and length in step 706. In one preferred embodiment, the user/accounting data 710 is stored in the user/chat database 409. The content clustering server then finishes itself and exits as in step 707.

### OBJECTIVES AND ADVANTAGES

One substantial advantage of the present invention is that it does not require any software installation or configuration change in the web servers of the content sites. Nor does it require any hosting service. This invention deliberately bypasses the complicated integration, configuration or hosting process for adopting chat room or real time collaboration software. As an alternative, with one-time client side installation, the user and expert can start to chat, exchange advice, present demo, show advertisement and even make a real deal on any page in Internet. This improvement brings the static web browsing experience to another level wherein the user not only browses the content and product in Internet but also may ask the expert for a quick question, making a real deal or seeing an alternative product or demo by the expert. The browsing and shopping experience will be promoted more frequently in real time communication and collaboration just like in the real world as the users wish.

The foremost objective of this invention is to attract experts to stay on line more often and longer to provide quality services with their expertise to users. Therefore, users can be benefited by always having on-line experts along with the content to provide the services when they need it. With the web-based client tool, experts may attach to the content most pertinent to their expertise with versatile options such as to attach by domains, by key words, by sponsored ads, by browsing categories and ranking or by just input content URLs. These flexible options will allow experts to find the most relevant content to attach with less effort.

With the standalone web-based client tool and the expert service server system, experts are provided numerous incentives to offer premium services to users. They can show their advertisement and product information to the user as soon as a chat session is initiated. Subsequently, they can even demo other content to the user if the user accepts the demo request. Finally, the expert can complete the sale of their product all within the web-based client tool. The present invention empowers the real life expert everything their need to leverage and utilize their expertise without any need to set up a chat room, a content web site or an e-commerce application.

What is claimed is:

1. A method for a content expert to attach or listen to any content or web page in Internet wherein the Internet user may see and select the relevant expert from the expert lists along with the content or web page they are browsing, comprising steps of:
(a) the content expert may attach or listen to any content from Internet in accordance with their expertise,
(b) wherein the user browses the content from Internet, the lists of experts are updated automatically based on the URL and the content that the user is browsing,
(c) by means of selecting an expert from the list, the user can start a chat session with the expert,
(d) hereafter a chat is initiated by the user, the expert can start to provide advice as well as expert services to the user.

2. The method of claim 1 wherein the expert inputs one or more Internet domains to listen on all the content and web pages under these Internet domains.

3. The method of claim 1 wherein the expert inputs a set of key words of search pages to listen on. The expert will be shown on the expert list to the user wherein the user searches the same set of key words with search pages. A list of popular search engines may be selected to more specifically limit the search pages the expert likes to listen only.

4. The method of claim 1 wherein the expert listens on the sponsored advertisement on search page or sponsored web sites. The expert inputs the sponsored advertisement into the system and attach to it. Then the expert will be shown in the expert list along the content whenever users see the same sponsored advertisement.

5. The method of claim 1 wherein the expert may browse and select the content URL by categories and ranking.

6. The method of claim 1 wherein the expert may input and attach on multiple web pages or URL from Internet at the same time. The multiple web pages may be related to the same subject, product, or services.

7. A method of periodical content processing to crawl, cluster, normalize and rank the content with chat data from the past user chat session, comprising steps of,
(a) crawling Internet content periodically
(b) clustering and storing the content by categories
(c) normalizing the resulting content URL
(d) reading user chat data
(e) ranking the content based on the user chat data
(f) providing clustered content for experts to listen to.

8. The method of claim 7 wherein the periodical process crawls Internet domain by domain and counting the key words inside the content. The frequency of key word then relates the content to a preset category hierarchy.

9. The method of claim 7 wherein the process normalizes the URLs by removing non-discriminative parameters in URLs. The minimized URL will point to the same content after normalization.

10. The method of claim 7 wherein the process ranks the content based on the frequency and length of the historic chat session data. Hereinafter, the expert may browse the URLs based on the ranking information to decide what URLs may have higher possibility for users to initiate a chat.

11. A web-based expert service system providing Internet user content related expert service including chat, advice, expert advertisement, expert product and expert demo, comprising:
a web-based client tool downloaded and installed in user's computer consisting of a built-in browser, a of experts related to the URL and content in the built-in browser and a expert service window,
an accounting server cluster storing user registration, chat session usage and ad/product impressions,
a chat server cluster establishing and managing the chat session between users and experts,
an expert service server cluster enabling experts to listen on clustered contents and providing expert services to users,
a content clustering server crawling, clustering, normalizing and ranking the content from Internet,
three database instances including user/chat database, expert service database and clustered content database.

12. The system of claim 11 wherein the web-based client tool provides experts the capability to listen on any web page in Internet.

13. The system of claim 11 wherein the web-based client tool provides a list of experts in the expert list window that is related to the URL and the content in the built-in browser window. The user may select any expert from the list of experts for any content from Internet in the built-in window to initiate a chat session with the expert.

14. The system of claim 11 wherein the expert service window of web-based client tool comprises a message window, a send message window, an expert advertisement and product information window with one “buy now” button during the chat session to allow the expert to chat, advice, show product and advertisement to the user.

15. The system of claim 11 wherein the expert service window of web-based client tool enables expert to demo product or content in the built-in browser window upon user's permission. Either the user or the expert can cancel the demo any time.

16. The system of claim 11 wherein the web-based client tool allows both experts and users to record and replay different recordings in the built-in browser window after the demo is completed.

17. The system of claim 11 wherein an accounting server cluster consisting of a plurality of accounting servers manages and stores user data and accounting information.

18. The system of claim 11 wherein a chat server cluster consisting of a plurality of chat servers manages and stores chat session data.

19. The system of claim 11 wherein an expert service server cluster, consisting of a plurality of expert service servers, manages and provides the expert services to the web-based client tool users. The expert services include but not limited to expert list provision, chat initiation, expert advice, expert advertisement, expert product information, expert product purchase, expert demo, etc.

20. The system of claim 11 wherein the content clustering server crawls Internet, clusters and stores content, normalizes URL and ranks the content according to the frequency and length of the chat session data. The clustering service provides the expert to browse and listen on normalized URLs of related contents by browsing categories and ranks.
